(19) United States
(12) Patent Application Publication
(10) Pub. No.: US 2023/0263192 A1
(43) Pub. Date: Aug. 24, 2023

(54) SPORTS DRINK AND METHODS OF MAKING SAME

(71) Applicant: AMBA Beverage Corporation, Los Angeles, CA (US)

(72) Inventor: Babak Taheri, Los Angeles, CA (US)

(21) Appl. No.: 18/109,799

(22) Filed: Feb. 14, 2023

Related U.S. Application Data
(60) Provisional application No. 63/311,898, filed on Feb. 18, 2022.

(51) Int. Cl. A23L 2/66; A23L 2/68; A23L 2/60

(52) U.S. Cl. CPC A23L 2/66; A23L 2/68; A23L 2/60

(57) ABSTRACT

Described and illustrated herein is an improved beverage composition and methods of making the same. The beverage composition is free of fat, is high in protein, and useful in muscle recovery after exercise.

### CROSS REFERENCE TO RELATED APPLICATIONS

This application claims priority to the earlier filing date of U.S. Provisional Patent Application Ser. No. 63/311,898, filed on Feb. 18, 2022, the content of which is hereby incorporated herein in its entirety.

### FIELD

The disclosed subject matter generally relates to consumable liquids and, more particularly, to drinks and beverages, including carbonated protein drinks, for improved muscle recovery.

### BACKGROUND

Energy drinks are highly sought after beverage products, especially among athletes. These drinks are commonly sold in venues such as gyms or competition circuits, where thirst and depletion can hinder athletic performance. Several types of energy drinks are currently available in the market place. Most of these energy drinks include high levels of sugar or caffeine, which provide a temporary boost of energy, but do not support an athlete with a meaningful recovery.

To address this issue, protein can be added to a beverage to provide for muscle recovery. Many of the currently available protein drinks in the market are difficult to drink, generally due to having an undesirable taste or consistency. Particularly, in relation to carbonated beverages that contain protein, addition of the protein makes the beverage cloudy, inconsistent, and therefore unappealing both a visually and for consumption purposes.

It is desirable for a beverage to taste refreshing and to not exhibit cloudiness or unappealing appearance or viscosity. Additionally, the pH level of the beverage needs to be carefully managed for shelf-life stability. Accordingly, a beverage and systems and methods for producing a beverage with high protein content are needed, such that the beverage has a pleasant taste and appearance with a prolonged shelf-life expectancy.

### BRIEF DESCRIPTION OF THE DRAWINGS

FIG. 1 is a flowchart of a method for making a beverage, in accordance with one or more embodiments.

### DETAILED DESCRIPTION OF EXAMPLE EMBODIMENTS

A great tasting protein beverage, and innovative methods and systems for making the same, are provided. Disclosed is also a recipe for an example carbonated protein beverage (e.g., sparkling protein water) with improved absorption and ability to induce high insulin concentration in the bloodstream. The beverage is suitable for consumption by athletes or consumers who wish to restore and build muscle strength and reduce potential muscle damage, dehydration, or injury after exercising or during competition.

In accordance with one or more embodiments, the beverage is a flavored (e.g., passionfruit, lemon, strawberry, caramel, mint, etc.) sparkling protein water that includes an extensively hydrolyzed protein. The protein may be whey protein that compared to the proteins used in conventional sports drinks can be digested and absorbed very fast due to the application of a hydrolysis process, which can include any chemical reaction in which a molecule of liquid (e.g., water) breaks one or more chemical bonds. The term as used is to be interpreted broadly for substitution, elimination, and solvation reactions in which a liquid used (e.g., water) is the nucleophile. The dosage of the hydrolyzed whey protein is selected to give an athlete the boost needed to induce higher muscle performance.

In certain aspects, the hydrolyzed whey protein is already broken down into small peptides and amino acids for faster access to the blood stream and results in a pre-digested state. This allows an athlete who consumes the beverage to benefit from optimal recovery conditions as well as a shorter wait time for achieving a peak training session following the consumption of the beverage. In some aspects, the whey protein may include, at least partially, a protein that has been extensively hydrolyzed. As such, if the beverage is consumed with carbohydrates, a high concentration of insulin is induced in the blood stream to help regulate blood sugar and build muscle.

Consuming a beverage that includes extensively hydrolyzed protein (e.g., Lacprodan® HYDRO.365) and carbohydrates, as disclosed herein, helps accelerate muscle recovery and replenishment by converting glucose into storage form (e.g., glycogen). Due to faster absorption in the blood stream, in comparison with other conventional sports drinks, the beverage helps increase muscle tissue recovery after exercise. The whey protein used in the formulation of the beverage has a superior amino acid composition, and faster absorption, due to high levels of dipeptides and tripeptides.

In certain aspects, the beverage may include a protein with short-chained peptides and a high content of dipeptides and tripeptides. The amino acid composition of an example protein (e.g., Lacprodan HYDRO.365) included in the beverage is given in Table 1 below. Tables 2 to 9 provide, without limitation, additional example details about the composition and physical properties of the protein. It is noteworthy that the provided measurements, ingredients and details are for the purpose of providing an enabling disclosure, but are in no way limiting and should not be construed as narrowing the scope of the claimed subject matter to such specific details.

TABLE 1
Amino Acids (AA).
TYPICAL AMINO ACID COMPOSITION G.AA/
100 G PROTEIN (N × 6.38)

| | | |
|---|---|---|
| Alanine | | 6.2 |
| Arginine | | 2.5 |
| Aspartic acid (asparagine) | | 11.9 |
| Cysteine (Cystine) | | 2.0 |
| Glutamic acid (glutamine) | | 20.4 |
| Glycine | | 1.7 |
| Histidine | * | 1.8 |
| Isoleucine | * | 6.4 |
| Leucine | * | 11.1 |
| Lysine | * | 10.8 |
| Methionine | * | 2.4 |
| Phenylalanine | * | 2.8 |
| Proline | | 6.5 |
| Serine | | 5.3 |
| Threonine | * | 7.5 |
| Tryptophane | * | 1.2 |
| Tyrosine | * | 2.6 |
| Valine | * | 6.0 |
| Total BCAA | | 23.5 |

*Essential Aminoacids

TABLE 2
Chemical Specifications.

| CHEMICAL | | Specification | | Typical |
|---|---|---|---|---|
| SPECIFICATIONS | Unit | Min. | Max. | value |
| Proteins as is (N × 6.38) | % | 82.0 | | 86.0 |
| Protein in dm (N × 6.38)* | % | 86.0 | | 90.0 |
| Lactose | % | | 4.0 | 1.9 |
| Fat | % | | 0.5 | 0.1 |
| Ash | % | | 5.0 | 2.8 |
| Moisture | % | | 6.9 | 5.4 |

*Limits are theoretically calculated from moisture and protein limits. Protein as is and moisture limits are used for release.

TABLE 3
Mineral Composition.

| | | Specification | | Typical |
|---|---|---|---|---|
| MINERALS | Unit | Min. | Max. | value |
| Sodium (Na) | % | | | 0.23 |
| Magnesium (Mg) | % | | | 0.08 |
| Phosphorus (P) | % | | | 0.21 |
| Chloride (Cl) | % | | | 0.04 |
| Potassium (K) | % | | | 0.49 |
| Calcium (Ca) | % | | | 0.78 |

TABLE 4
Physical Specifications.

| PHYSICAL | | Specification | |
|---|---|---|---|
| SPECIFICATIONS | Unit | Min. | Max. |
| pH | 10% sol | 5.9 | 7.0 |
| Scorched particles | Disc | A | |
| Bulk density (625×) | g/cm3 | 0.2 | 0.5 |
| Solubility index | ml | | 0.1 |

| | | |
|---|---|---|
| Colour | Description | White to yellow |
| | | with good uniformity |
| Flavour/odour | Description | Free from foreign |
| | | odours and flavours |
| Texture | Description | Powdered, uniform |
| | | product |

TABLE 5
Microbiological Specifications.

| MICROBIOLOGICAL | | Specification | |
|---|---|---|---|
| SPECIFICATIONS | Unit | | Max. |
| Total plate count (30°) | CFU/g | | 10,000 |
| Enterobacteriaceae | CFU/g | | <10 |
| Bacillus cereus | CFU/g | | <100 |
| Sulph. red. clostridia | CFU/g | | <100 |
| Yeast & mould | CFU/g | | <50 |
| | Sample size | n | Absent in |
| Staphylococcus aureus | 0.2 g | 5 | 1 g |
| Salmonella | 25 g | n | 125 g |

TABLE 6
Nutritional Values (per 100 g product).

| | | |
|---|---|---|
| Energy | 1,469/346 | kJ/Kcal |
| Calories from fat | 1 | Kcal |
| Protein (N × 6.25) | 84.2 | g |
| Carbohydrate | 2 | g |
| of which dietary fiber | 0 | g |
| of which sugars | 2 | g |
| of which added sugars | 0 | g |
| Fat | 0.1 | g |
| of which saturated fat | 0.1 | g |
| of which trans fat | 0 | g |
| Cholesterol | n.a. | |
| Salt | 0.6 | g |
| Sodium | 235 | mg |
| Vitamin D | n.a. | |
| Calcium | 0.8 | % |
| Iron | n.a. | |

EU: Energy value is calculated according to Regulation (EU) No 1169/2011 of the European Parliament and of the Council of 25 Oct. 2011 on the provision of food information to consumers.

TABLE 7
Allergens.

| | | | DESCRIPTION |
|---|---|---|---|
| | | | OF |
| YES | NO | ALLERGENS | COMPONENTS |
| | • | Cereals containing gluten and | |
| | | products thereof | |
| | • | Crustaceans and products thereof | |
| | • | Eggs and products thereof | |
| | • | Fish and products thereof | |
| | • | Peanuts and products thereof | |
| | • | Soya beans products thereof | |
| • | | Milk and products thereof | Bovine milk |
| | | (including lactose) | |
| | • | Nuts | |
| | • | (Tree) Nuts and products thereof | |
| | • | Celery and products thereof | |
| | • | Mustard and products thereof | |
| | • | Sesame seeds and products thereof | |
| | • | Sulphur dioxide and sulphites | |
| | | (>10 mg/kg) | |
| | • | Lupin and products thereof | |
| | • | Molluscs and products thereof | |

TABLE 8
Peptide Distribution (typical).

| Mw (Dalton) | Weight |
|---|---|
| <375 | ~17.5% |
| 375-750 | ~37.9% |
| 750-1250 | ~25.8% |
| 1250-2500 | ~16.9% |
| >2500 | ~1.9% |

TABLE 9
Molecular Distributions.

| MOLECULAR | | Specification | |
|---|---|---|---|
| DISTRIBUTIONS | Unit | Min. | Max. |
| Degree of hydrolysis | % | 26 | 31 |
| Mw. mean molecular weight | | | |
| based on weight at 214 nm | | 750 | 1,100 |
| Mn. mean molecular weight | | | |
| based on weight at 214 nm | | 450 | 700 |

In certain embodiments, the formulation of the beverage is high in hydrolyzed protein, low in carbohydrates, and fat free. The hydrolyzed protein includes a high content of dipeptides and tripeptides makes the protein heat-stable throughout the pH range and fully water-soluble. Additionally, the beverage produced based on the provided formulation has very low viscosity and is a clear solution throughout the pH range. In one aspect, the hydrolyzed protein is sourced from 100% whey protein with a low bitterness profile.

In accordance with one or more embodiments, a beverage composition for use in protection of the muscular system suitable for human consumption is provided. The beverage composition may, for example, include 1.7% to 5% weight over volume (w/v) of a hydrolyzed whey protein; 0.25% to 1.00% w/v of an acid; at least one flavoring agent or flavorant; at least one coloring agent or colorant; a carbohydrate; and water. An example recipe for the formulation of protein water, in accordance with one or more embodiments, is given in Table 10 with the nutritive values per 100 mL serving as given in Table 11 below.

TABLE 10
Recipe.

| | |
|---|---|
| Lacprodan*HYDRO.365 | 4.650% |
| Citric Acid | 0.500% |
| Sucralose Splenda Liquid Concentrate | 0.013% |
| Flavour, Bitter blocker SC092033, IFF | 0.100% |
| Flavour, Passionfruit P105942, Ungerer & Co | 0.100% |
| Flavour, Lemon EW110856, Ungerer & Co | 0.030% |
| Colour, Beta-carotene BC-200-WSS, | 0.005% |
| Christian Hansen | |
| Water | 94.591% |

TABLE 11
Nutritive values per 100 mL serving.

| Energy kcal (Calculated) | 16 Kcal |
|---|---|
| Protein | 4.0 g |
| Fat | 0.0 g |
| Carbohydrates | 0.1 g |

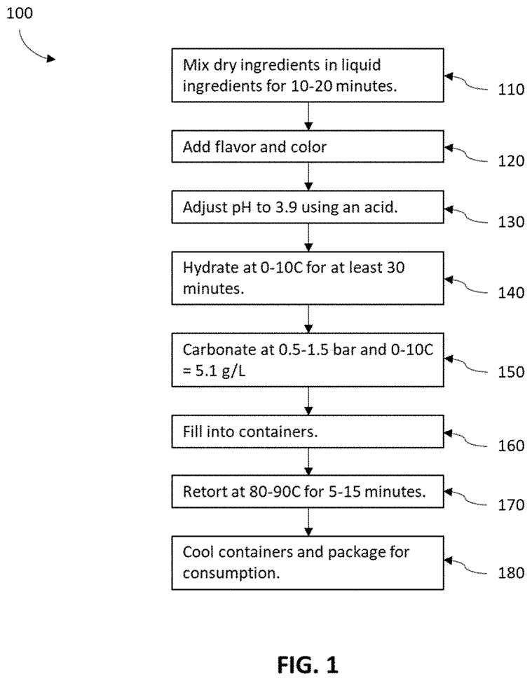

Referring to FIG. 1, an example method 100 for making a beverage in accordance with one or more embodiments is provided. Dry ingredients including a protein (e.g., Lacprodan HYDRO.365) and an acid are mixed with liquid ingredients (e.g., Sucralose Splenda® liquid concentrate and water) (110). The dry ingredients may be mixed with the liquid ingredients for 10-20 minutes, for example. In some implementations, the dry ingredients are mixed with the liquid ingredients for about 15 minutes.

In certain aspects, flavorants and colorants may be added to the mixture (120). The pH of the mixture may be adjusted to a suitable level (e.g., about 3.9), for example, using an acid or acidic solution (130). The mixture may be hydrated for a suitable time period (e.g., at least 10 to 30 minutes) at a temperature of zero to ten degrees Celsius, for example (140). In some implementations, the mixture is hydrated at a temperature of approximately five degrees Celsius. It is noteworthy that the temperature, timing, and pH values and levels indicated are exemplary approximations and may vary in different embodiments.

In some embodiments, the mixture is carbonated, for example, at a pressure of about 0.5-1.5 bars and a temperature of about zero to ten degrees Celsius, to achieve a carbonation of approximately 5.1 g/L, for example (150). The carbonation process (and certain other disclosed processes or steps) may be optional and not necessary in accordance with certain aspects. In some implementations, the mixture is hydrated at an approximate pressure of 0.9 bars and an approximate temperature of six degrees Celsius, for example. The mixture is placed into containers or receptacles configured for holding a beverage for shipping and ultimately for human consumption (160).

In some implementations, the containers may be cans or bottles made of plastic, aluminum, glass, or paper-sourced material. Other suitable container structure or material is within the scope of this disclosure as well. The containers may be heated at a temperature of approximately 80-90 degrees Celsius for about 5 to 15 minutes, for example (170). In one implementation, the containers are heated at a temperature of 85 degrees Celsius and may remain heated for approximately 10 minutes, for example. The containers may be cooled and prepared for packaging and shipping (180).

In one example embodiment, the beverage may include one or more of the following ingredients: caffeine, ginseng, guarana, maca, yerba mate, B vitamins (e.g. niacin (B3), folic acid (B9), riboflavin (B2), cyanocobalamin (B12), pyridoxine hydrochloride (B6), pantothenic acid (B5)), taurine, L-carnitine, sugar, sugar substitutes (e.g. artificial sweeteners, sucralose, sugar, sugar alcohol, stevia, allulose, Splenda®, monk fruit, etc.), creatine, Branched Chain Amino Acids (BCAA), or other amino acid components, such as those disclosed in Tables 1 to 11.

In this disclosure, the term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified (e.g., hydroxyproline, γ-carboxyglutamate, and O-phosphoserine). Amino acid analogs refers to compounds that have the same basic chemical structure as a naturally occurring amino acid (e.g., an a carbon that is bound to a hydrogen), a carboxyl group, an amino group, and an R group (e.g., homoserine, norleucine, methionine sulfoxide, methionine methyl sulfonium). Such analogs have modified R groups (e.g., norleucine) or modified peptide backbones, but retain the same basic chemical structure as a naturally occurring amino acid. Amino acid mimetics refers to chemical compounds that have a structure that is different from the general chemical structure of an amino acid, but that functions in a manner similar to a naturally occurring amino acid. The terms “non-naturally occurring amino acid” and “unnatural amino acid” refer to amino acid analogs, synthetic amino acids, and amino acid mimetics which are not found in nature.

Amino acids may be referred to herein by either their commonly known three letter symbols or by the one-letter symbols recommended by the IUPAC-IUB Biochemical Nomenclature Commission. Nucleotides, likewise, may be referred to by their commonly accepted single-letter codes. The terms “polypeptide,” “peptide” and “protein” are used interchangeably herein to refer to a polymer of amino acid residues, wherein the polymer may be conjugated to a moiety that does not consist of amino acids. The terms apply to amino acid polymers in which one or more amino acid residue is an artificial chemical mimetic of a corresponding naturally occurring amino acid, as well as to naturally occurring amino acid polymers and non-naturally occurring amino acid polymers.

The terms “comprises,” “comprising,” “containing” and “having” and the like can have the meaning ascribed to them in U.S. Patent law and can mean “includes,” “including,” and the like. “Consisting essentially of or “consists essentially” likewise has the meaning ascribed in United States patent law and the term is open-ended, allowing for the presence of more than that which is recited as long as basic or novel characteristics of that which is recited is not changed by the presence of more than that which is recited, but excludes prior art embodiments.

Further, in the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.”

While this specification contains many specifics, these should not be construed as limitations on the scope of what is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination.

Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A beverage composition comprising:
1.7% to 5% w/v of a hydrolyzed whey protein;
0.25% to 1.00% w/v of an acid;
at least one flavorant;
at least one colorant;
a carbohydrate; and
a liquid.

2. The beverage composition of claim 1, wherein the carbohydrate is present in an amount that induces a high concentration of insulin in the bloodstream of a human consumer after the beverage is consumed.

3. The beverage composition of claim 1, wherein the beverage composition has a fat content of approximately zero.

4. The beverage composition of claim 1, wherein the acid is citric acid.

5. The beverage composition of claim 1, wherein the hydrolyzed whey protein includes at least an amount of Lacprodan® HYDRO.365.

6. The beverage composition of claim 1, wherein the beverage composition has low viscosity and clear appearance throughout the pH range.

7. The beverage composition of claim 1, wherein the beverage composition has a low bitterness profile.

8. The beverage composition of claim 1, wherein the carbohydrate is a sweetener.

9. The beverage composition of claim 8, wherein the sweetener includes one or more of sucralose, sugar, sugar alcohol, stevia, allulose, or monk fruit.

10. The beverage composition of claim 1, wherein the pH of the composition is at least 3.9.

11. The beverage composition of claim 1, wherein the liquid is water.

12. A method of preparing a beverage composition suitable for human consumption, the method comprising:
combining hydrolyzed whey protein with citric acid to form one or more dry ingredients;
combining liquid carbohydrate concentrate with a liquid to form one or more liquid ingredients;
mixing the one or more dry ingredients and the one or more liquid ingredients for 10-20 minutes to create a mixture;
adding flavorant and colorant to the mixture;
adjusting the pH of the mixture using an acid;
hydrating the mixture at a temperature of 0-10 degrees Celsius for at least 10-30 minutes;
carbonating the mixture at a temperature of 0-10 degrees Celsius and 0.5-0.9 bars to a carbonation of about 5 grams per liter;
heating the mixture to a temperature of 80-90 degrees Celsius for 5-15 minutes; and
cooling the mixture.

13. The method of claim 12, wherein the mixing of the one or more dry ingredients and the one or more liquid ingredients is performed for at least 15 minutes.

14. The method of claim 12, wherein the mixture is hydrated at a temperature of at least 5 degrees Celsius.

15. The method of claim 12, wherein the mixture is carbonated at a temperature of at least 6 degrees Celsius.

16. The method of claim 12, wherein the mixture is heated to a temperature of 85 degrees Celsius for at least 10 minutes.

17. The method of claim 12, wherein the beverage composition is used for protection of the muscular system.

18. The method of claim 12, wherein the fat content of the beverage composition is zero.

19. The method of claim 12, wherein the acid is citric acid.

20. The method of claim 12, wherein the carbohydrate is a sweetener.

21. The method of claim 20, wherein the sweetener is one or more of sucralose, sugar, sugar alcohol, stevia, allulose, or monk fruit.

22. The method of claim 12, wherein the hydrolyzed whey protein is Lacprodan® HYDRO.365 and the carbohydrate is present in an amount equal to 0.1 grams per 100 mL of beverage composition.
